(19) United States
(12) Patent Application Publication
(10) Pub. No.: US 2019/0166823 A1
(43) Pub. Date: Jun. 6, 2019

(54) Selective Action Animal Trap

(71) Applicant: Aaron Dick, Houston, TX (US)

(72) Inventor: Aaron Dick, Houston, TX (US)

(73) Assignee: Caldera Services LLC, Houston, TX (US)

(21) Appl. No.: 16/121,703

(22) Filed: Sep. 5, 2018

Related U.S. Application Data
(60) Provisional application No. 62/594,121, filed on Dec. 4, 2017.

(51) Int. Cl. A01M 31/00; G06K 9/00; G06K 9/62; A01M 29/24; A01M 23/02; A01M 23/38; A01M 29/16; A01M 23/18

(52) U.S. Cl. CPC A01M 31/002; G06K 9/00369; G06K 9/628; G06K 9/627; H04L 67/12; A01M 23/02; A01M 23/38; A01M 29/16; A01M 23/18; A01M 29/24

(57) ABSTRACT

A method and a system provide an animal trap that records digital images of animals with a camera, convolves the digital image with a kernel to create convolved feature maps that are used as input to a classifier algorithm, producing classification confidence scores that identify the animals. An algorithm categorizes the classified animal and selects an action based on the categorization. The trap has actions to deter the benign or beneficial animals and actions to detain or kill the pest animals. With this method and system, the trap is able to target pest animals with minimal harm to benign or beneficial animals.

This application claims priority to U.S. provisional application Ser. No. 62/594,121 filed on Dec. 4, 2017, which is incorporated by reference in its entirety.

### TECHNICAL FIELD

This invention relates to pest control, and more specifically to animal traps used in pest control.

### BACKGROUND

In their natural environment, pest animals are often comingled with benign and beneficial animals that are of similar size and have similar behaviors. Conventional animal traps that target a pest animal risk accidental detention, killing or maiming non-pest animals. Examples are found in residential settings, industrial farming, and invasive species eradication.

Non-limiting examples of pest animals are rats, mice, raccoons, skunks, nutria, opossums and coyotes. Several of these pests are similar in size as common pets or livestock such as cats, pigs, chickens and dogs. Other animals that might coexist with these animals may be wild, but not considered pests such as squirrels. Given these possible similarities in body size and shape, physical barriers that selectively exclude benign or beneficial animals from the pest trap are difficult or impossible to design. In invasive species eradication, a natural ecosystem has been disrupted or is threatened by a pest species. In an example, Africanized honey bees and European honey bees are similar in body size, shape and behavior making it difficult to construct traps that differentiate between them.

It is desirable yet difficult to identify pests from non-pests for the purpose of animal traps and many investigators have proposed solutions. Examples include Meehan (U.S. Pat. No. 4,884,064) who describes a plurality of sensors for detecting presence of a pest. The sensors are to be unresponsive to animals that are of a different size than the pest. Guice et. al. (U.S. Pat. No. 6,653,971) describes a system for discriminating between harmful and non-harmful airborne biota. The proposed methods require directed energy beams and energy absorbent backstops to generate a return signal that may be used in a pest, non-pest classifier. Anderson et. al. (U.S. Pat. No. 6,796,081) utilizes a maze structure to protect against access by children, pets or non-target species. Kates (U.S. Pat. No. 7,286,056) describes an energy beam and receiver to detect presence of a pest when the beam is interrupted. Arlichson (U.S. Pat. No. 9,003,691) proposes a trap door cage utilizing a sensor to detect an animal in the trap and trigger the closing of a trap door. Kittelson (U.S. Pat. No. 9,439,412) proposes a non-lethal animal trap utilizing a microprocessor and motion sensor to detect objects within the trap and activate an electrically controlled latch to close the trap doors.

While these methods have been proposed, a practical, low cost, reliable and accurate method for excluding non-pest animals from a pest animal trap has remained elusive. It is clear that there is a need for an improvement.

### SUMMARY OF THE INVENTION

This invention provides a method and a system for an animal trap that classifies animals approaching and entering the trap by general visual appearance. With this method and system, the trap is able to target pest animals with minimal harm to benign or beneficial animals despite similarities in size, shape, color and behaviors.

Digital images of animals in proximity to the trap are acquired by a camera and analyzed by a computer algorithm by convolving the digital image with a kernel to create a convolved feature map. The feature maps are further processed with a computer algorithm machine learning classifier to provide a confidence score for each animal. The animal confidence scores are then compared with threshold values and if the value is exceeded for an animal, then an algorithm categorizes the animal and selects trap action. If the animal is categorized as a pest animal, the trap control system detains or kills the animal. If the animal is categorized as a non-pest animal, the trap control system either deters the animal from entering the trap, or takes no action.

The system consists of the camera, the computer with software programs containing image convolution, classifier, and trap control algorithms, and the trap data acquisition and control hardware with a data acquisition and control bus, relays, latches, transformers, emitters and sensors to enable multiple trap response actions.

Several embodiments are included in the following description in conjunction with the drawings. All patents, patent applications, articles and publications referenced within the description are incorporated by reference in their entirety. To the extent that any inconsistencies or conflicts in definitions or use of terms exist between the references and the present application, the present application shall prevail.

### BRIEF DESCRIPTION OF THE DRAWINGS

FIG. 1. Component overview of first embodiment

FIG. 2. Component overview of the first embodiment data acquisition and control system.

FIG. 3. Grayscale image convolution with a Sobel filter, not to scale.

FIG. 4. Example Haar kernels for creating convolved image descriptors.

FIG. 5. Example Histogram for creating histogram of oriented gradients (HOG) convolved image descriptors.

FIG. 6. Color image convolution for a convolutional neural network, not to scale.

FIG. 7. Software program flow chart for the second embodiment.

### DETAILED DESCRIPTION OF REPRESENTATIVE EMBODIMENTS

To promote the understanding of the invention, specific embodiments will be described. While the invention is shown in only a few of its forms, it should be apparent to those skilled in the art that it is not so limited but is susceptible to various changes without departing from the scope of the invention.

References herein to computers generally means the computer functional assembly that may include but is not limited to combinations of processing circuitry, central processing unit (CPU), graphics processing unit (GPU), tensor processing unit (TPU), application specific integrated circuit (ASIC), field programmable gate array (FPGA), hardware accelerators, data buses, network connection interfaces, computer readable media (CRM), volatile and non-volatile memory, auxiliary storage, input/output components such as screen, keyboard, mouse and other connected peripherals, software operating systems, general purpose software, and specialized function software.

In addition, references to communication networks and interfaces generally means public or private networks, the Internet, intranets, wired or wireless networks, local area networks (LAN), wide area networks (WAN), satellite, cable, mobile communications networks and hotspots. The communications networks may utilize some form of communication protocols such as internet protocol (IP), transmission control protocol (TCP), or user datagram protocol (UDP). The communications network includes devices such as routers, gateway, wireless access points (WAP), base stations, repeaters, switches and firewalls.

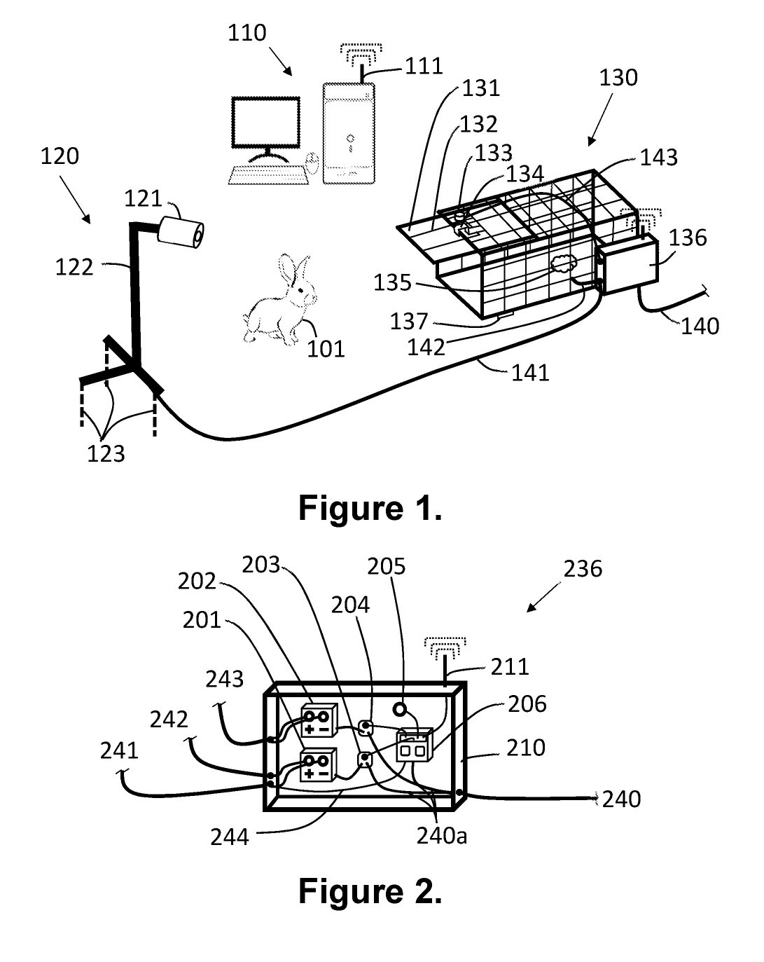

In the first embodiment, referring to FIG. 1, the animal trap is composed of a wire cage trap assembly 130, trap door 131 with spring activated pivot latch 132 and pivot latch catch mechanism 134. An electromechanical latch 133 holds the trap door 131 open and is switched by electrical power supplied by a wire 143 from the control system 136. A bait 135 is placed in the wire cage trap assembly 130 to attract target animals 101. A high voltage wire 142 connects to the wire cage trap assembly 130. Electrically isolating feet 137 insulate the wire trap cage assembly 130 from the ground. A system power cable 140 is routed to the control system 136. A camera assembly 120 is positioned in proximity to the trap 130 to acquire digital images. A camera 121 is positioned on the distal end of a riser 122 to provide the camera a favorable perspective to image animals 101 approaching the wire cage trap assembly 130. Ground stakes 123 secure the riser 122 to the ground and provide an electrical ground reference for the control system 136. The camera power, data transfer, and the ground reference wires are routed to the control system 136 by a multiconductor cable 141. A remotely located first computer workstation 110 has a network communication interface 111 and provides training for the classifier used by the control system 136.

Referring to FIG. 2. The trap control system 236 is enclosed in a weatherproof enclosure 210. It contains a second computer or microcontroller 206, electronic relays 203 and 204, a proximity sensor 205, an electromechanical switch power supply 202 and a high voltage transformer 201. System power is supplied to the control system 236 by a power cable 240 and is distributed inside the weatherproof enclosure 210 by wires 240a. The second computer 206 acquires data from the camera by cables 241 and 244 and from a proximity sensor 205 that is directed into the trap to detect position of the animal inside the cage. The second computer 206 controls relay 204 that switches the power supply to the electromechanical latch wire 243 so that when the relay 204 is activated, the trap door 131 (FIG. 1) will close. The second computer 206 controls relay 203 that switches the high voltage transformer power supply 201 that is connected to ground by a wire in the multiconductor cable 241 and the trap assembly wire 242 to optionally provide a deterrent electrical shock to non-target animals. The second computer 206 has a network communication interface 211.

The digital image acquired from the camera is stored in CRM as a numerical array of pixel color intensity values. For example, an image acquired by the camera may have a width of 640 pixels and a height of 480 pixels and be recorded in a Red, Green, Blue (RGB) or YCbCr color space to have array dimensions of 640×480×3. A method for producing accurate image classification with computer vision has been the use of a convolution algorithm whereby the original pixels values are convolved with a numerical array whose width and height are smaller than the image width and height, known in image processing and computer vision literature as a filter, kernel, convolution matrix, mask, cell or window. The resulting output from the convolution operation are commonly known as the filtered image, convolved image, convolved image descriptor, convolved feature map or activation map.

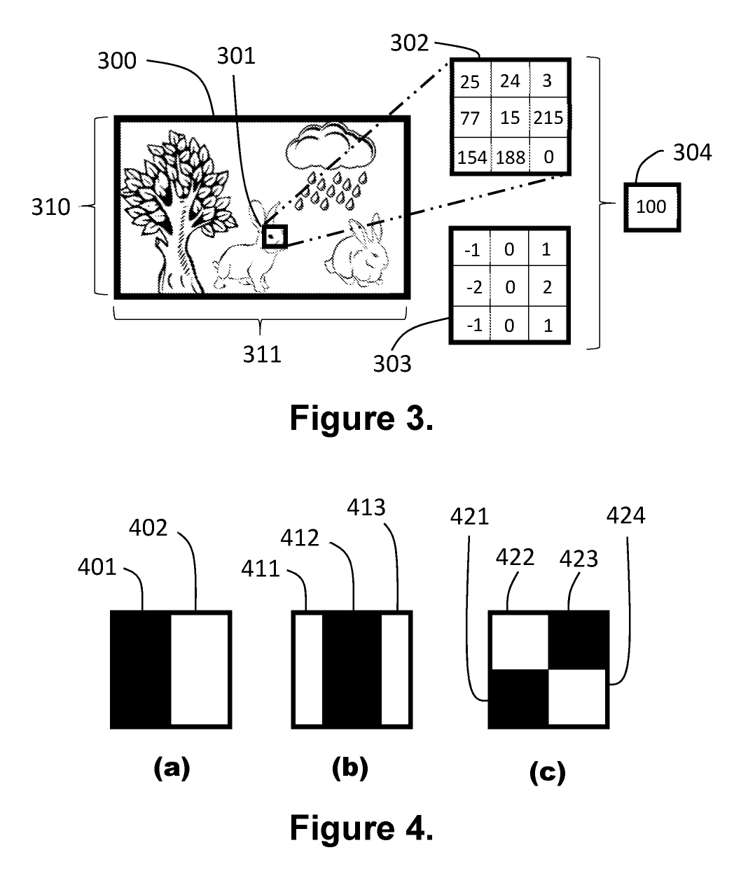

Referring to FIG. 3, in a simple image convolution example, the kernel elements 303 are oriented over a position 301 on the greyscale image 300 that is stored in CRM as a numerical array that is shaped 640×480×1 elements. The image area elements 302 included within the bounds of the kernel position 301 has shape 3×3×1 elements. The values in these elements are the greyscale intensity values ranging from 0 (black) to 255 (white). In this example, the kernel elements 303 is a horizontal gradient filter known as an X Sobel filter. The kernel elements 303 are first flipped in x and y directions, then the image area elements 302 are element wise multiplied with kernel elements 303, and them summed to create a convolved output value 304. This process is repeated by moving the kernel position with a stride of 1 element for every location in the greyscale image 300 typically proceeding left to right, top to bottom to create a filtered image with the same spatial orientation as the input image.

In a Haar feature object detector (Viola et. al. 2001), the image is typically first converted to grayscale. In this method, several different kernels are convolved with the input image. The kernels contain 2 regions described by 2 or more rectangles. Referring to FIG. 4, several example kernels are shown. Kernel 4a has 2 rectangles 401 and 402, the kernel 4b has 3 rectangles 411, 412, and 413, and the kernel 4c has 4 rectangles 421, 422, 423, and 424. The convolution is performed by first summing pixel values in each region then calculating the difference between pixel value sums from each region to create a convolved image descriptor. These convolved image descriptors are used as the input for an adaptive boost (AdaBoost) machine learning algorithm that calculates object classification scores.

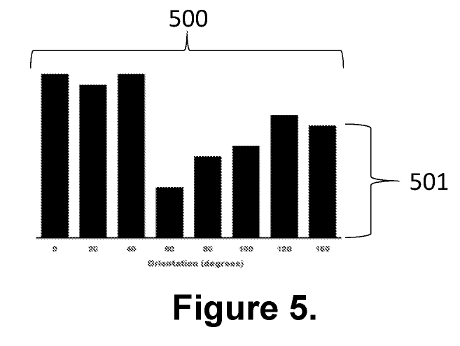

In a histogram of oriented gradients (HOG) object detector (Dalai et. al. 2005) and McConnel (U.S. Pat. No. 4,567,610), the kernel defines a window of pixel values called a cell that is convolved with a horizontal and vertical gradient filter to produce a set of gradient directions and magnitudes for each pixel. These gradient values for pixels within a cell are used to create a histogram, FIG. 5, where the bins 500 represent gradient directions and the height of each bin 501 represents the summed gradient magnitudes. Representations of these histograms are assembled into an output vector that is used as the input for a support vector machine (SVM) machine learning algorithm that produces object classification scores.

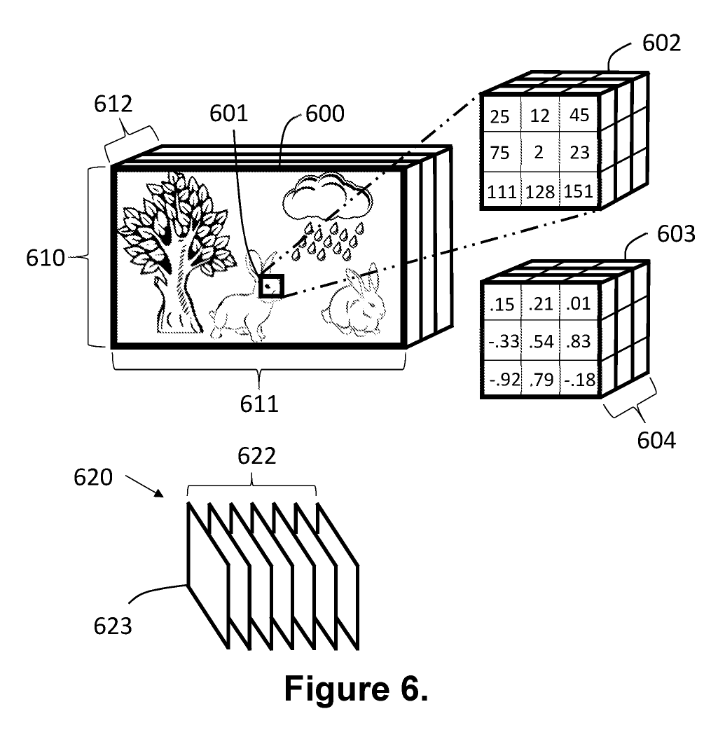

In a convolutional neural network (CNN) classifier, the kernel is typically 3×3×3 or 5×5×3 elements in shape for a color depth 3 image. Referring to FIG. 6, an example of a CNN image convolution procedure is shown. The original color image 600 has a pixel width 611, height 610, and a color depth 612. The kernel is oriented in a position 601 in the image 600. Within the bounds of the kernel, the image numerical array elements 602 contain pixel color intensity values. The kernel element array 603 has the same depth dimension 604 as the image color depth 612. The kernel array values are typically initialized at the beginning of training by a random number generator to values between −1 and 1. As in the previous example (FIG. 3), the image pixel values 602 and kernel values 603 are element-wise multiplied, then summed to a single value and stored in an activation map 623. The rastering of the kernel across the image typically proceeds with a stride of 1 or 2 pixels until the activation map 623 is populated. The procedure is repeated for several kernels and the activation maps are stacked 622 into an output volume 620. While the FIG. 6 shows 7 activation maps, CNN classifiers may have hundreds of activation maps in a convolution output volume 620.

The CNN kernel values are learned during training of the CNN classifier. A loss function is generated based on comparison of the predicted classifications with ground truth classifications of the training images. Gradient descent by back propagation of error defined by the loss function is used to modify the kernel values in an optimization process (Nielsen 2015, Rumelhart et. al. 1986). Current state of the art CNN based classifiers contain an architecture of multiple convolution operation layers typically combined with a softmax output layer to produce classification scores expressed as a probability. The architectures also include node weight regularization, normalization, pooling, dropout layers, different optimizers and other mathematical manipulations to improve computational efficiency and classification performance.

An extension of the CNN classifier is the region-based convolutional neural network (RCNN) whereby regions of interest (ROI) are generated as cropped subset portions of the original image by random assignment or by a region proposal network (RPN). Each subset portion is analyzed by the classifier algorithm, allowing for multiple instances of animals and their positions to be detected within the original image.

Several non-limiting examples of convolved image feature based classifiers have been described. Each classifier uses different methods, but all produce classification confidence scores that may be used to identify and differentiate between animals. Each classifier has different advantages and disadvantages when considering speed of training, prediction accuracy after training on limited image sets, ability to detect multiple object instances, image variation from camera sensor wavelength sensitivities and lighting conditions, prediction analysis loop times, computer memory consumption, and parallel processing efficiency. Another variable is that low cost computers are continually improving in processing power. As a result, embodiments may use different algorithms for different applications and evolutions of trap design.

After a convolution feature based classifier has been trained on a set of animal training images, it can be used for prediction to identify animals located within a newly acquired digital image. The classifier will produce a set of confidence scores for all animals that were included in the training image set. In a successfully trained classifier, the confidence score for an animal contained in the new input image will be high and animals not contained in the input image will have a low relative confidence score. Thus, for application in pest, non-pest detection, it is necessary to acquire a set of training images of the pest and non-pest animals and running the training procedure prior to deployment. However, differences in lighting, within species variation of the pest and non-pest animals, presence of new animals unknown to the classifier, or other factors may cause the animal trap pre-trained classifier to not meet sufficient classification confidence score differentiation between pest and non-pest animals to prevent misclassification errors and erroneous trap action. When the trap classifier attempts to classify an animal, but the classification probability does not meet a predefined threshold, the computer software or human operator may optionally instruct the trap to take no action except to acquire images of the animal for use in further training.

In a second embodiment, the wire cage trap assembly has a trap door with spring loaded pivot brace and pivot brace latch as in the first embodiment. A first computer is a 4-core CPU workstation with a 1664 processing core GPU and software to enable general purpose GPU computing that is located remotely from the wire cage trap assembly. The first computer is connected to the LAN with an ethernet cable. The second computer located in a weatherproof box attached to the wire cage trap assembly is a low-cost credit card sized micro-computer with a 4-core CPU and a general-purpose input output (GPIO) bus connected to 2 relays and an analog input. The second computer and GPIO interface controls the first electronic relay to switch the power source to the high voltage transformer, a second electronic relay to switch power to an electromechanical latch holding the trap door open, and to an analog output infrared proximity sensor to measure animal position within the trap. The second computer has a wireless connection to the LAN by way of a WAP.

In the second embodiment, the classifier training is accomplished by placing a digital camera in proximity to the baited trap to acquire training images. The trap doors are locked open, allowing animals to enter and exit unhindered. The camera contains a conventional complementary metal-oxide-semiconductor (CMOS) sensor with visible light and infrared wavelength detection. The camera also has infrared illumination that is autonomously turned on by the camera in low visible light conditions. The camera utilizes IP communication by an ethernet cable connected to the second computer. The second computer acquires a stream of digital images from the camera and applies a gaussian mixture model (GMM) adaptive motion detector. When motion is detected, digital images from the camera are saved as files on the second computer that are later transferred to the first computer over the network. This process is sustained, re-baiting the trap as needed, until a training image set of the animals is acquired. Preferably, this training image set includes at least 100 different images capturing different perspectives of each animal. Optionally, the training image set may be further expanded by converting some color images to greyscale to simulate infrared illumination images. In addition, an image augmentation procedure may be used to create random shifts, shears, rotations and flips to the images to create more image variations for each animal. A human operator defines the ground truth ROIs and animal classifications for each image used in the training set using an object tagging software tool on the first computer. In addition to the training images containing animals (positives), a set of non-animal images (negatives) are included in the training set for background reference. Ten percent of the positive training images are randomly selected and removed from the training set to serve as a test image set.

The second embodiment classifier model structure contains region proposal, convolution and classification algorithms based on Krizhevsky (2012) and Girshick (2015) known as a Fast-RCNN classifier. Model training is performed on the first computer GPU. Using transfer learning (Garcia-Gasulla et. al. 2017, Yosinski et. al. 2014), a pre-trained CNN is used in the model to reduce the computation time required to train on the set of animal images. The Fast-RCNN model is trained on the image set for approximately 8 hours or until the confidence score accuracy on the test image set is greater than predetermined threshold values. A non-limiting example Fast-RCNN training threshold expressed as a probability is 75% for each animal class. When training is completed, the trained Fast-RCNN classifier model is transferred to the second computer CRM.

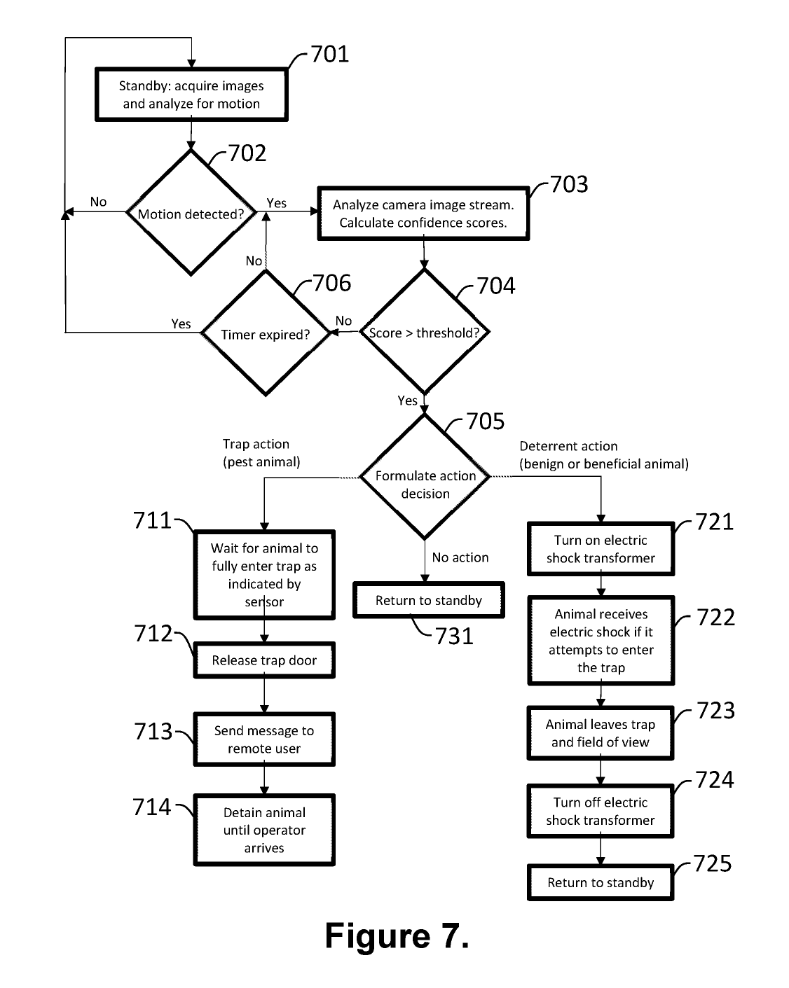

The second embodiment metal cage assembly trap door locks are removed and the trap is baited to prepare for normal operation. Referring to FIG. 7. The embodiment computer software algorithm begins in a standby state 701 with GMM motion detection and trained Fast-RCNN classifier modules running in a continuous process loop on the second computer. The software program reads images continuously streamed from the camera and analyzes them for motion 702. If motion is detected, a software timer is set. A non-limiting example of the software timer duration is 30 seconds. The trained Fast-RCNN software analyzes camera images in a continuous stream at approximately 2 images per second and animal classification confidence scores are averaged over several consecutive images to further reduce likelihood of incorrect classification 703. In a non-limiting example, 5 image confidence scores are averaged for each animal class. The averaged confidence scores are then compared with predetermined prediction threshold values for each animal class 704. If no confidence scores exceed the thresholds, the timer expiration is checked 706. If the timer has not expired, the Fast-RCNN continues analysis of the image stream 703. If the timer has expired, system returns to standby 701. If averaged classification confidence scores exceed predetermined prediction thresholds for any animal class 704, the program proceeds to the action decision step 705. A non-limiting example threshold expressed as a probability is 60%. The action decision algorithm 705 may be generic and select kill or detain action if the animal is a pest animal and deterrent action if the animal is non-pest. Alternately, the action decision algorithm may include data regarding animal behaviors, customer preferences, or environmental factors gathered from various sources including local or remote databases, internet information services or other sensors located on the trap. For example, if an animal is detected and classified to be an animal that is known to hibernate during winter, and season and temperature data acquired from an internet information service suggest the animal should be hibernating, the trap action decision algorithm may dismiss the detection and classification as erroneous. In another example, the action decision algorithm may use lower relative threshold values for pets or sensitive species and higher relative threshold values for target pests to protect against erroneous trap action.

If the action decision algorithm 705 selects deterrent action, the second computer switches a GPIO digital output and connected power relay to turn on the power to the high voltage transformer 721. The metal cage is energized by the high voltage transformer to approximately 2000 volts and delivers a deterrent electric shock to the animal if it contacts the metal cage 722. The high voltage transformer remains powered until the software timer expires 723, then the second computer switches the GPIO digital output and connected power relay to turn the high voltage transformer off 724. The system returns to standby 725, 701.

If the action decision algorithm 705 selects kill or detain action for a pest animal, the second computer monitors the analog input data acquired through the GPIO bus from the proximity sensor 711. When the sensor signal indicates the animal is centrally positioned within the trap, the second computer switches a GPIO digital output and connected power relay to actuate the door latch thus releasing the trap doors 712. A message is sent to the first computer or another network connected device that an animal has been trapped 713. The metal cage trap assembly detains the animal until a human operator arrives 714.

If multiple pest and non-pest animals are detected simultaneously, or if a sensitive non-pest animal is detected, the action decision algorithm 705 may select no action, the timer is allowed to expire and the system returns to standby 731, 701.

The classification model may be pre-trained on images from other sources than the camera to minimize or negate the need for on-site training. Classification models for a particular pest application may be selected from a library of specialized models that are pre-trained on animals or within species variation anticipated for the specific application. The pre-trained models may be downloaded to the trap by over-the-air network software updates from a remote location. The computer or microprocessor on the trap may act as a server and client to message a remote user or server with images from the camera, current state of the trap and history of the animal detections and trap actions, or any related operational or system status information. The trap computer may be network connected to a platform as a service (Paas) or internet of things (IoT) information system for messaging, data downloads and over-the-air software updates.

In other embodiments, one or multiple cameras may be deployed to image the trap, inside the trap and the area in proximity to the trap. An actuator may be used to open and close one or more trap doors as instructed by the computer and may include application customizable actions such as closing the trap doors during daylight hours to better target a nocturnal animal, or responding to non-pest animals by closing the trap doors to prevent them from accessing the bait, or hold the doors in a closed position until a pest animal is detected. The trap may have one or more deterrent actions in place of or in addition to electric shock such as emitting pressure waves in the audible or ultrasonic range or electromagnetic radiation. The trap may have kill actions such as electrocution, pressure waves, percussion, or electromagnetic radiation.

In still other embodiments, the classification algorithm used in combination with the convolution algorithm may be different machine learning methods known within the body of knowledge such as boosted or randomized classification trees, and logistic regression. Variants of CNN and RCNN based algorithms such as described in U.S. patent application Ser. No. 15/001,417, U.S. patent application Ser. No. 15/379,277, and publications He 2017, Sabour 2017, He 2015 and Szegedy 2015 may be used. Open source code libraries implementing some of these approaches are available on the Internet.

An embodiment may have an auto-dispensing bait system or use light, chemical attractant or pheromone in place of the bait. An embodiment may not use a bait, but instead be placed or transported along a common travel route so that animals pass through the trap. An example common travel route may be a migration route such as a fish ladder. An embodiment may be configured not to have an enclosure or doors. For example, the trap may be a pad with embedded electrodes with bait placed in the center to draw the pest across the electrodes and the embodiment selects between a deterrent shock and an electrocution shock or other deterrent or kill action depending on the animal classification.

An embodiment may direct insects past a camera then divert them into release or kill/detention passages through the trap depending on the classification. An embodiment may be used for aquatic animals entering the trap at least partially submersed in a stream, river, lake, or ocean.

Embodiments may be applied to environmental management, biology or ecology studies where the animals are not categorized as pest, non-pest, but as different species or within species variants that are categorized as target and non-target.

### CONCLUSION

Although the description of specific embodiments has been included, these should not be construed as limitations on the scope, but rather as an exemplification of possible embodiments. The selective action trap is able to identify animals by general appearance and thus has many advantages:
The trap is able to exclude pets, or other non-pest animals from the trap, even if they have similar body shape or size, thus avoiding accidental detention, killing or maiming.
The trap can be configured so that kill or detain actions are only enabled when a target animal is detected, making the system safer for non-target animals or humans.
The trap is able to differentiate between subtle differences in target animal appearance such as within species variation.
The trap action is software customizable to requirements of a specific application.
The trap action software customization and modification can be performed remotely through a network.
It is possible to construct embodiments of the trap from low cost, readily available components.

### REFERENCES

Viola, P. et al., 2001, “Rapid Object Detection using a Boosted Cascade of Simple Features,” Proc. Conf. Computer Vision and Pattern Recognition, 2001.
Dalai, N. and B. Triggs, 2005, Histograms of Oriented Gradients for Human Detection. Proc. Conf. Computer Vision and Pattern Recognition, 2005.
Nielsen, Michael (2015). “Neural Networks and Deep Learning”, http://neuralnetworksanddeeplearning.com
Rumelhart, D. E., G. E. Hinton, and R. J. Williams, 1986, Learning internal representations by error propagation, Parallel distributed processing: explorations in the microstructure of cognition, vol. 1, pp. 318-362.
Krizhevsky, A., I. Sutskever, G. E. Hinton, 2012, Imagenet classification with deep convolutional neural networks, Advances in neural information processing systems, pp. 1097-1105.
Girshick, R., 2015, Fast R-CNN, International Conference on Computer Vision, 2015.
Garcia-Gasulla, D., A. Vilalta, F. Pares, J. Moreno, E. Ayguade, J. Labarta, U. Cortes, T. Suzamura, 2017, An out-of-the-box full-network embedding for convolutional neural networks. https://arxiv.org/abs/1705.07706
Yosinski J., Clune J., Bengio Y., and Lipson H., How transferable are features in deep neural networks? In Advances in Neural Information Processing Systems 27 (NIPS '14), NIPS Foundation, 2014.
Sabour, S., N. Frosst, 2017, Dynamic routing between capsules, NIPS 2017, Long Beach, Calif., USA. He, K., G. Gkioxari, P. Dollar, R. Girschick, 2017, Mask R-CNN, https://arxiv.org/abs/1703.06870.
Szegedy, C., W. Liu, Y. Jai, P. Sermanet, S. Reed, D. Anguelov, D. Erhan, V. Vanhoucke, A. Rabinovich, 2015, Going deeper with convolutions, Proc. Conf. Computer Vision and Pattern Recognition, 2015.
He, K. X. Zhang, S. Ren, J. Sun, 2015, Deep residual learning for image recognition, https://arxiv.org/abs/1512.03385.

What is claimed is:

1. A selective action animal trap system comprising one or more digital cameras located in proximity to a trap, connected to computer processing circuitry configured to process the image data into convolution feature maps, that are further processed by computer processing circuitry into animal classification confidence scores, and selecting the action of the trap to one of; no action, deter, detain or kill based on the classification confidence scores.

2. The system of claim 1 wherein the computer processing circuitry executes a pre-trained convolutional neural network classifier or region-based convolutional neural network object detector.

3. The system of claim 1 wherein the trap action detains an animal in a wire cage trap assembly by closing one or more trap doors.

4. The system of claim 1 wherein the trap action deters or kills an animal by electrical shock, pressure waves, percussion, or electromagnetic radiation.

5. The system of claim 1 wherein the said computer processing circuitry sends and receives network messages with a remote user containing current and historical operational state information.

6. A method for trapping an animal, comprising:
acquiring a set of digital images of one or more animals,
by way of convolution and classification algorithms run on a computer, process the said digital image set to train the algorithm parameters to create a pre-trained convolution and classification algorithm,
acquiring digital images from a camera located in proximity to a trap,
by way of the said pre-trained convolution and classification algorithm run on a computer, produce animal classification confidence scores for each image,
by way of a trap action algorithm run on a computer, selecting the trap action to; no action, deter, kill or detain based on the animal classification confidence scores.

7. The method of claim 6 wherein the said convolution and classifier algorithms are applied to more than one Regions of Interest (ROI) within the digital image and assigning animal classification confidence scores to each ROI.

8. The method of claim 6 wherein the said convolution and classifier algorithms are a convolutional neural network classifier or region-based convolutional neural network object detector.

9. The method of claim 6 wherein the trap action detains an animal in a wire cage trap assembly by closing one or more trap doors.

10. The method of claim 6 wherein the trap action deters or kills an animal by electrical shock, pressure waves, percussion or electromagnetic radiation.

11. The method of claim 6 wherein the said computer sends and receives network messages with a remote database or user containing current and historical operational state information.

12. The method of claim 6 wherein the said trap action algorithm incorporates information from network information services and databases.

13. The method of claim 6 wherein the said computer algorithms are replaced or modified by over-the-air network updates.

14. A method for trapping an animal, comprising:
acquiring digital images from a camera located in proximity to a baited wire cage trap assembly with open trap doors,
by way of a software program run on a computer, analyzing the said digital images using a Gaussian Mixture Model (GMM) motion detector to determine if an animal is present,
by way of a software program run on a computer, when said animal is detected by said GMM motion detector, further processing the digital images with a pre-trained convolution neural network and classification algorithm to generate animal classification confidence scores,
by way of a software program run on a computer, comparing the said animal classification confidence scores to threshold values and actuating the trap if the score of one or more animal classes exceeds the threshold value,
by way of a software program run on a computer and trap control system, selecting the trap action to detain pest animals by closing the trap doors, or deterring non-pest animals from entering the trap by electrifying the cage to deliver a non-lethal shock.

15. The method of claim 14 wherein the convolution neural network and classification algorithm is pre-trained on a set of animal digital images to have classification confidence score accuracy expressed as a probability of more than 70% for each animal class.

16. The method of claim 14 wherein the said computer sends and receives network messages containing current and historical operational state information with remote databases and users.

17. The method of claim 14 wherein the said computer software programs are replaced or modified by over-the-air network updates.
